(19) United States
(12) Patent Application Publication
(10) Pub. No.: US 2026/0338283 A1
(43) Pub. Date: Oct. 29, 2026

(54) ROTARY VALVE

(71) Applicant: TI Automotive Technology Center GmbH, Rastatt (DE)

(72) Inventors: Johannes GOELLER, crispenhofen (DE); Matthias WINTER, Karlsruhe (DE)

(21) Appl. No.: 19/104,912

(22) PCT Filed: Aug. 9, 2023
(86) PCT No.: PCT/EP2023/072052

§ 371 Date: Feb. 19, 2025

(30) Foreign Application Priority Data
Aug. 19, 2022 (EP) 22191246.2

(51) Int. Cl. F16K 11/06; F01P 7/14

(52) U.S. Cl. CPC F16K 11/06; F01P 7/14; F01P 2007/146

(57) ABSTRACT

A rotary valve includes a valve housing with a valve chamber, wherein the valve chamber has at least one chamber wall in which at least two fluid openings are introduced. The valve chamber accommodates a valve core, wherein the valve core is provided with a channel structure which interacts with the fluid openings. The valve core is rotatorily accommodated in the valve chamber, and the valve core is formed in at least two parts.

### RELATED APPLICATIONS

The present disclosure claims priority to and is a national phase application of PCT Application PCT/IB2023/072052, filed Aug. 9, 2023, which claims priority to European Patent Application 22191246.2, filed Aug. 19, 2022, the entire contents of which are incorporated herein by reference.

### FIELD

The disclosure relates to a rotary valve, comprising a valve housing with a valve chamber, wherein the valve chamber has at least one chamber wall in which at least two fluid openings are introduced, wherein the valve chamber accommodates a valve core, wherein the valve core is provided with a channel structure which interacts with the fluid openings, wherein the valve core is rotatorily accommodated in the valve chamber.

### BACKGROUND

Such a rotary valve is known, for example, from DE 10 2018 009 680 A1. Rotary valves of the mentioned type are often used in cooling circuits to control the flow of coolant. A cooling fluid can flow in and out through the fluid openings introduced in the valve housing. The channel structure introduced in the valve core controls the coolant flow, wherein, depending on the embodiment and number of fluid openings, different cooling circuits can be activated, the volume flow can be regulated or the flow direction adjusted.

The embodiment as a rotary valve is advantageous because the coolant flow is adjusted by rotating the valve core, wherein the corresponding actuator for rotating the valve core is formed in a simple manner and can be easily controlled. Accordingly, rotary valves and the associated actuators can be manufactured in a cost-effective manner. In addition, rotary valves require only a small installation space.

Such rotary valves are particularly advantageous with regard to the use in temperature control circuits in the field of electromobility. To achieve a high range for electric vehicles, for example, it is necessary to control the temperature of electrical components. The components of electric vehicles whose temperature needs to be controlled are, in particular, electrical energy storage units, but also the power electronics or connectors of fast-charging devices. An electrical energy storage device has a best possible capacity only in a very small temperature spectrum. Therefore, it is necessary to heat electrical energy storage devices of electric vehicles at low ambient temperatures and to cool them at high outside temperatures or during high load changes.

For this purpose, it is known to provide a temperature control circuit through which a temperature control medium flows. Depending on the requirements, the temperature control medium can either be heated in a heating device or cooled in a cooling device. The control of the temperature control medium flow is at least partially performed via a rotary valve. This can result in the need for complex channel structures in the valve core.

### SUMMARY

The present disclosure provides a rotary valve which can be manufactured at low cost, and which allows for a complex control of temperature control circuits.

The rotary valve according to the disclosure comprises a valve housing with a valve chamber, wherein the valve chamber has at least one chamber wall in which at least two fluid openings are introduced, wherein the valve chamber accommodates a valve core, wherein the valve core is provided with a channel structure which interacts with the fluid openings, wherein the valve core is rotatorily accommodated in the valve chamber, wherein the valve core is formed in at least two parts.

Due to the at least two-part embodiment of the valve core, it is possible to realize complex channel structures in the valve core, wherein the valve core can be manufactured simply and cost-effectively at the same time.

The valve core can have at least one inner part and one outer part, wherein the outer part surrounds the inner part at least partially on the circumference side. In this embodiment, the inner part is inside the outer part, for example inserted into the outer part, which enables the embodiment of a particularly complex channel structure, in particular in the inner part. The outer part, on the other hand, is in contact with the chamber wall of the valve chamber and can be formed in such a way that it creates a particularly good seal against the chamber wall.

It is conceivable that multiple inner parts are provided. In such a case, multiple inner parts can be nested inside each other. Alternatively, it is also conceivable that multiple inner parts are provided, each of which extends over a circular sector, wherein multiple inner parts are arranged next to each other allocated around the circumference. In both embodiments, particularly complex channel structures can be formed cost-effectively. According to a further alternative, multiple inner parts can also be inserted into one another and further inner parts can be arranged next to one another.

The outer part can be formed as a sleeve and accommodate the at least one inner part. In this embodiment, the outer part can at least partially cover the inner part in the circumferential direction, so that the inner part is particularly well protected against damage. In particular, the inner part can be prevented from jamming against the chamber wall. The outer part, which is formed as a sleeve, protects the inner part particularly well against damage, in particular during assembly. With this embodiment, the outer part can also come to rest flat against the chamber wall of the valve chamber, so that the risk of internal leaks within the rotary valve can be reduced.

To improve the seal, the chamber wall can be provided at least in sections with an elastic coating, for example made of elastomeric material.

The at least one inner part can be formed rib-like. As a result, the inner part can be formed in a particularly light and material-saving manner, and the inner part can be optimized for the transport function of the channel structure. The outer circumferential side wall of the channels formed in the inner part can be formed by the outer part, which simplifies the manufacture of the inner part. If the inner part is formed of plastic, injection molding is particularly suitable for manufacturing. A rib-like embodiment of the inner part also allows for realizing particularly complex channel structures in the valve core.

Openings can be introduced in the outer part. Depending on the position of the valve core, the openings are in contact with the fluid openings and allow the temperature control medium to pass through the fluid openings into the channel structure of the inner part.

The channel structure can be formed in the at least one inner part. In doing so, the channel structure is protected by the outer part and a particularly complex channel structure can be realized.

The at least one inner part and the outer part can be connected to one another in a materially bonded manner. For this purpose, the at least one inner part and the outer part can be connected with an adhesive. Preferably, the at least one inner part and the outer part are connected to each other via a welded joint, for example by means of laser welding or ultrasonic welding. The welded joint can be formed in a line-type manner and be arranged around the openings, for example. It is also conceivable that the welded joint arranged around the opening is recessed, so that the weld seam does not impair the sealing function between the valve core and the valve housing. Thanks to the material bond, the inner part and outer part form a solid bond, so that a safe and durable operation of the rotary valve is ensured.

The at least one inner part and the outer part can be connected to each other in a form-fitting manner. With this embodiment, the inner part and outer part can be connected to each other particularly quickly and easily. It is also conceivable to connect the inner part and outer part to each other in both a materially bonded and a form-fitting manner.

The at least one inner part and the outer part can be connected to each other in a fluid-tight manner. This can prevent a liquid from flowing from one channel of the channel structure of the inner part into another channel of the channel structure.

The outer part of the valve core can rest against the chamber wall of the valve chamber in a sealing manner, at least in sections. This way, it can be prevented that leaks occur inside the valve chamber, which can impair the functionality of the rotary valve.

A sealing contour can be allocated to the outer part and/or the inner part. The sealing contour is preferably arranged on the outside in the region of the openings of the outer part and can be formed, for example, along the circumferential edges of the openings. The sealing contour can be a separate component or molded directly onto the outer part. In particular, it is conceivable to form the sealing contour of thermoplastic elastomer and mold it directly with the outer part. It is also conceivable to form the sealing contour as a sealing ring or sealing lip. Furthermore, the sealing contour can be arranged in a groove formed in the outer part.

In alternative embodiments, the valve housing and the valve core are formed in a conical shape. In addition, it is conceivable that the outer part is provided with a channel structure. Furthermore, it is conceivable to arrange multiple outer parts inside one another, wherein one outer part accommodates another outer part. The outer part can be formed multi-part, in particular in the form of circular sectors. In this context, it is particularly conceivable that the outer part comprises two half shells.

### BRIEF DESCRIPTION OF THE DRAWINGS

One embodiment of the rotary valve according to the disclosure is explained in more detail below with reference to the figures. The figures show, in each case schematically:

FIG. 1 a rotary valve;

FIG. 2 the valve core of the rotary valve in detail;

FIG. 3 the inner part of the valve core in detail;

FIG. 4 the outer part of the valve core;

FIG. 5 a further embodiment of a valve core;

FIG. 6 a valve core where the inner part and the outer part are welded together.

### DETAILED DESCRIPTION

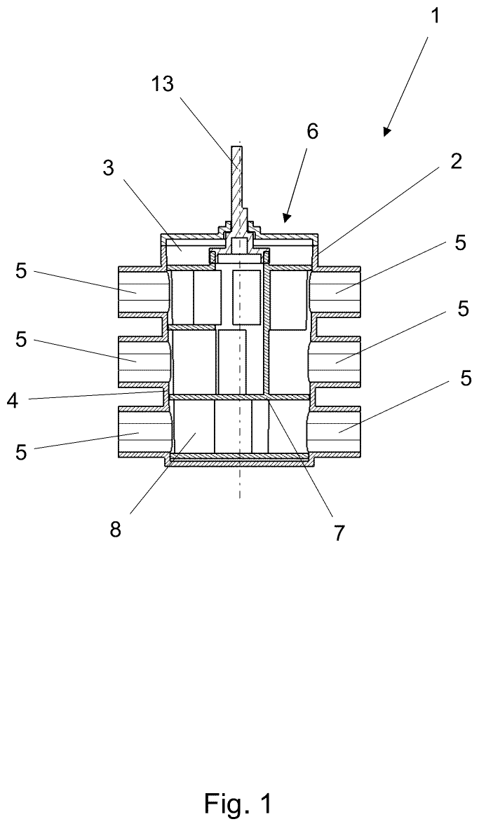

FIG. 1 shows a rotary valve 1, which forms a part of a temperature control circuit of an indoor unit to be air-conditioned. In the present case, the rotary valve 1 is used in electromobility applications as part of the temperature control circuit of an electric vehicle. The rotary valve 1 is integrated into a temperature control circuit of an electric motor drive of an electric vehicle and directs volume flows of the medium conducted in the temperature control circuit to the electrical energy storage devices and electric motors as well as to the power electronics. The temperature control medium flows of the temperature control circuit can be modified using the rotary valve 1.

In particular, it is conceivable to modify the volume flow of the temperature control medium, for example, to increase or decrease it. Furthermore, by rotating the valve core 7, different fluid openings 5 can be connected in a flow-conducting manner, thus the direction of flow of the temperature control medium can be changed. In this respect, the rotary valve 1 according to the disclosure also forms a directional control valve through which various components of the equipment to be temperature-controlled can be individually and specifically supplied with temperature control medium and, if necessary, also separated from the temperature control medium flow.

Depending on the ambient temperature and power requirement, for example, a temperature control medium flow can initially be directed exclusively to the electrical energy storage devices and cool or heat the electrical energy storage devices there depending on the ambient temperatures. For high power requirements, a coolant flow can be directed to the power electronics and also to the electric motors to cool these components. The modification of the coolant flow takes place by means of the rotary valve 1. In this case, the rotary valve 1 can replace multiple solenoid valves, so that the temperature control circuit can be produced in a cost-effective manner.

FIG. 1 shows a rotary valve 1 with a valve housing 2 formed of plastic, in which a valve chamber 3 is arranged. The valve chamber 3 has a chamber wall 4 in which multiple fluid openings 5 are introduced. The valve chamber 3 has a receiving opening 6 on the end face and the valve chamber 3 accommodates a valve core 7. The receiving opening 6 is provided with a cover in which a bushing for the drive shaft 13 is introduced. The valve core 7 is provided with a channel structure 8 which interacts with the fluid openings 5. The valve core 7 is rotatorily accommodated in the valve chamber 3 and provided with a drive shaft 13 via which the valve core 7 can be set in rotation by an actuator.

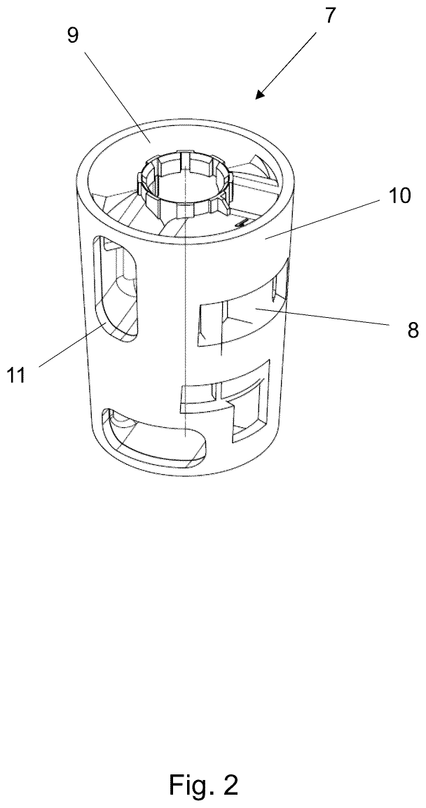

FIG. 2 shows the valve core 7 of the rotary valve 1 according to FIG. 1 in detail. The valve core 7 has an inner part 9 and an outer part 10, wherein the outer part 10 surrounds the inner part 9 on the circumference side. The outer part 10 is formed as a sleeve and accommodates the inner part 9. The inner part 9 and the outer part 10 are formed of plastic.

Openings 11 are introduced in the outer part 10. The channel structure 8 is formed in the inner part 9. The channel structure 8 is selectively in contact with one or more fluid openings 5 via the openings 11 introduced in the outer part 10.

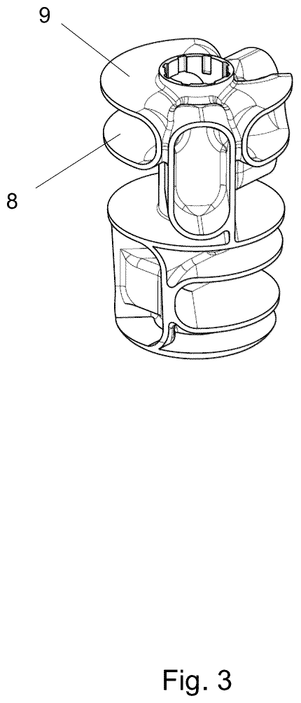

FIG. 3 shows the inner part 9 of the valve core 7 shown in FIG. 2 in detail. It can be seen that the inner part 9 is formed in a rib-like manner. The inner part 9 is formed of plastic and manufactured by injection molding. Depending on the embodiment of the channel structure 8, it is conceivable to form the inner part 9 in a multi-part manner, wherein multiple inner parts 9 can be inserted into one another and/or multiple inner parts 9 can be arranged in the form of circular sectors next to one another when viewed in the circumferential direction. In the inner part 9, the channel structure 8 is formed.

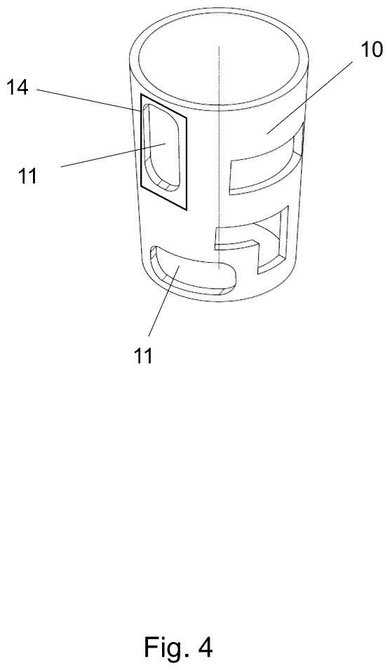

FIG. 4 shows the outer part 10 of the valve core 7 shown in FIG. 2 in detail. The outer part 10 is formed as a sleeve, wherein multiple openings 11 are introduced in the circumferential wall. The openings 11 are each associated with a sealing contour 14, which is arranged in the region of the edges of the openings 11. The sealing contour 14 is formed of thermoplastic elastomer and is firmly connected to the outer part 10.

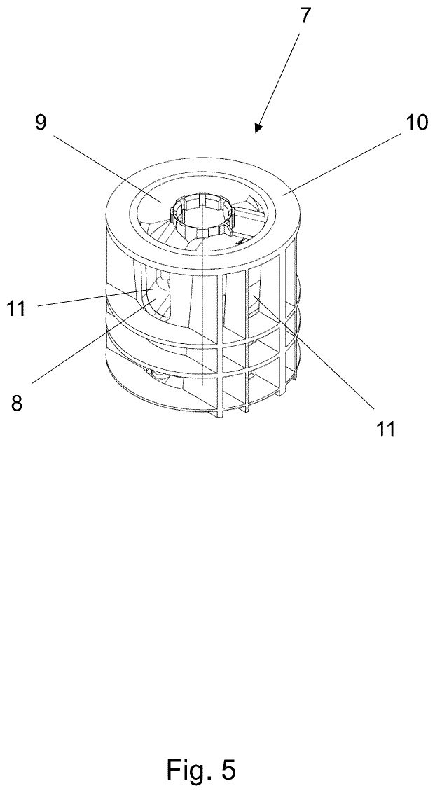

FIG. 5 shows an alternative embodiment of the valve core 7 shown in FIG. 2. In the present embodiment, the outer part 10 is also formed in a rib-like manner, so that the channel structure 8, which is formed in both the inner part 9 and the outer part, can have a particularly complex shape.

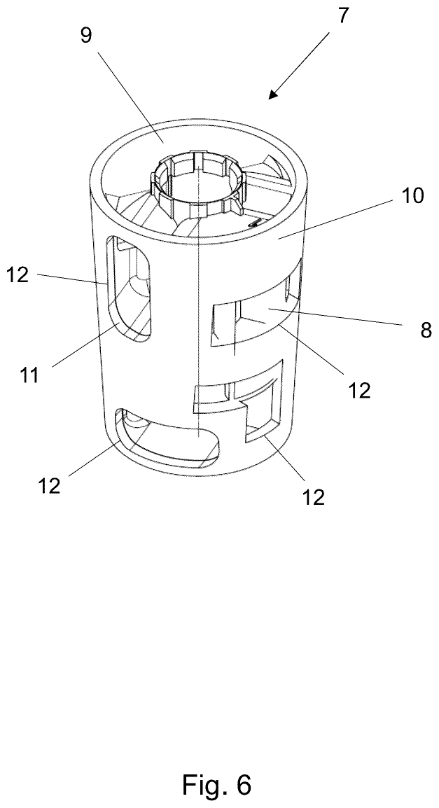

FIG. 6 shows the valve core 7 according to FIG. 2. In the present embodiment, it can be seen that the inner part 9 and the outer part 10 are connected to each other by a welded joint 12 in a material bond. The welded joint is arranged in the regions of the openings 11 and is formed linear in shape. In addition to the secure connection of the inner part 9 and outer part 10, the welded joint 12 ensures that no leaks occur within the valve core 7 in the region of the openings 11.

1. A rotary valve, comprising a valve housing with a valve chamber, wherein the valve chamber has at least one chamber wall in which at least two fluid openings are introduced, wherein the valve chamber accommodates a valve core, wherein the valve core is provided with a channel structure which interacts with the fluid openings, wherein the valve core is rotatorily accommodated in the valve chamber, and wherein the valve core is formed in at least two parts.

2. The rotary valve according to claim 1, wherein the valve core has at least one inner part and one outer part, wherein the outer part surrounds the at least one inner part least partially on the circumference side.

3. The rotary valve according to claim 1, wherein the outer part is formed as a sleeve and accommodates the at least one inner part.

4. The rotary valve according to claim 2, wherein openings are introduced in the outer part.

5. The rotary valve according to claim 2, wherein the channel structure is formed in the at least one inner part.

6. The rotary valve according to claim 2, wherein the at least one inner part is formed in a rib-like manner.

7. The rotary valve according to claim 2, wherein the at least one inner part and the outer part are connected to one another in a materially bonded manner.

8. The rotary valve according to claim 2, wherein the at least one inner part and the outer part are connected to one another in a form-fitting manner.

9. The rotary valve according to claim 2, wherein the outer part of the valve core rests against the chamber wall of the valve chamber in a sealing manner at least in sections.

10. The rotary valve according to claim 2, wherein a sealing contour is allocated to the outer part and/or the at least one inner part.

11. The rotary valve according to claim 1, wherein the valve core is formed of plastic.

12. The rotary valve according to claim 2, wherein at a channel structure is formed in the outer part.

13. The rotary valve according to claim 2, wherein the valve core has multiple outer parts.

14. The rotary valve according to claim 1, wherein the valve housing and the valve core are formed of plastic.

15. A temperature control circuit of an electric vehicle, comprising at least one rotary valve configured according to claim 1.
